(19) United States
(12) Patent Application Publication
(10) Pub. No.: US 2021/0377616 A1
(43) Pub. Date: Dec. 2, 2021

(54) SYSTEM AND METHOD FOR SHARED VIEWING OF LIVE TV AND ONLINE CONTENT

(71) Applicant: Michael Behagen, Strassbourg (FR)

(72) Inventor: Michael Behagen, Strassbourg (FR)

(21) Appl. No.: 17/395,269

(22) Filed: Aug. 5, 2021

Related U.S. Application Data
(63) Continuation-in-part of application No. 17/330,877, filed on May 26, 2021, now abandoned.
(60) Provisional application No. 63/029,755, filed on May 26, 2020.

(51) Int. Cl. H04N 21/4788; H04N 21/2187; H04N 21/44

(52) U.S. Cl. CPC H04N 21/4788; H04N 21/44; H04N 21/2187

(57) ABSTRACT

Method and system for creating a shared viewing experience, the method including receiving a request for joint viewing of a video or movie, forwarding the request to predefined additional potential participants to consent to participate in the shared viewing experience, creating a real time new video that includes three or four video layers and broadcasting the new real time video to all participants who consented to participate.

### CROSS REFERENCE TO RELATED APPLICATIONS

This is a continuation-in-part (CIP) of U.S. patent application Ser. No. 17/330,877 filed May 26, 2021, and claims the benefit of priority from U.S. provisional patent application No. 63/029,755 filed May 26, 2020, which is incorporated herein by reference in its entirety.

### FIELD

The present disclosure relates to compressed digital video delivery systems such as cable TV (CATV), satellite TV, Internet protocol TV (IPTV) and Internet-based video distribution systems. In particular, it relates to allowing a group of viewers to watch selected video or film content in such a way that the video or film are synchronously displayed and the viewers are able to see each other.

### BACKGROUND

Over the past two decades, many developments have been made in smart TV technology, including fast Internet connection, smart operating systems and improved set top boxes. Many new technologies have become available, including different types of content viewing, such as shared viewing of VOD movies on sites such as Netflix or Amazon, shared viewing of TV channels broadcast live via a network, watching movies on a movie server and videos on a user's smartphone or other device.

In view of the large number of people who live under isolated conditions, there is an unmet need to provide them with a virtual experience of shared live events. Moreover, the COVID-19 coronavirus pandemic has led to lockdowns and further isolation of otherwise socially-active individuals and families This has led to a further unmet need for virtual events such as concerts, movies, sporting events and games.

There is thus an unmet need for providing individuals and families with virtual live events, viewable from an isolated location, such as, but not limited to, a home, hospital room, hotel room or prison cell. Despite availability of collaborative programs, which allow movie screening, such as Zoom, very little emphasis is given to the user viewing experience. There is an unmet need for a method and system, which provide a remote user with a virtual event, but with the feel of a real event with a live audience.

### SUMMARY

It is an object of the present disclosure to provide methods and systems which create a virtual movie or sport viewing experience to remotely-dispersed viewers, similar to that experienced by participants in a real movie theater or stadium with a live audience. This experience is the ability, while watching a movie or other show or program, to be with friends, see them, hear them, communicate with them, etc.

There is thus provided according to some embodiments of the present disclosure, a method and system for creating a shared viewing experience for users, the method comprising receiving a request for joint viewing of a video or movie, forwarding the request to predefined additional potential participants to consent to participate in the shared viewing experience, creating a real time new video that includes three video layers and broadcasting the new real time video to all participants who consented to participate.

There is thus provided according to some embodiments of the present disclosure a method and system for providing a remote individual or group of individuals with a virtual live experience of an event, such as a theater viewing of a video, film or a program online. The remote viewers are able to experience an atmosphere similar to that experienced in a real movie theater or other event with a real audience. The virtual event is organized by a person, who is an “organizer” (or host”) of such a remote event.

According to some further embodiments of the present disclosure, there is provided a method and system for using the data from the homes or other locations of a remotely-dispersed audience, together with data from a central computer or a TV station to enhance the virtual live experience of an event.

According to some further embodiments of the present disclosure, there is provided a method and system for providing a virtual seating plan in which a plurality of individuals located at different locations watch an event such as a film or a program, all at the same time, from different remote locations together with the organizer.

The plurality of individuals are able to each sit at a virtual seat in the virtual event location, such as by allowing them to sit virtually in front of, next to or behind the organizer, e.g. in chairs of a movie theater, just like in a real movie theater. For example, a computer program obtains an image of each user, using his/her smart phone camera or other camera. The camera connects his/her face to his/her body to appear to be sitting in the virtual movie theater, or alternatively, translates his/her head movements as provided by his/her camera as if viewed from his/her back like in a real movie theater, while using and maximizing the standard equipment that may be found in almost every remote location, such as a home, where a computer or TV set top box is located.

According to some further embodiments of the present disclosure, there is provided a method and system for providing a virtual movie or sport viewing experience to individuals, at dispersed remote locations, similar to that experienced in a real movie theater or stadium with a live audience. This is performed by using data from the dispersed remote locations of the individuals and enabling them to watch the event together with the user. By tracking the individuals in real time and using data from a central computer or station, the virtual event is “brought to life” to provide a feel of a live audience event.

The systems and methods of the present disclosure enable people from all over the globe to watch a film/movie, together with the host, with the experience that they are sitting together at the same event location, such as in armchairs of a movie theater. This is performed by use, and sometimes maximizing use, of standard equipment and technology which is typically found in many locations and homes, where a computer is located.

The systems and methods of the present disclosure provide, according to some embodiments, a remote user experience of a virtual event, similar to the feel of a real event with a live audience, such as a cinema experience. There are many occasions which a group of people would like to participate or collaborate, while watching a live event and/or video content. Some non-limiting examples include sports, educational, gaming, news and work-related events.

Many educational establishments, such as schools, have event/conference rooms from where the school may multicast a lecture/class to their students. Some hospitals have capabilities to show every step of a real-time surgery, live to an audience. The students or the doctors may want to watch the lecture or surgery together, so that they may share their viewpoints while watching the event/content remotely.

Many TV game shows provide means for interaction with the audience through concepts or simply asking the audience to vote on a specific question or scene. There are also gaming applications where the TV station shows remote players or the remote players may want to see one another and chat about the game while playing it.

Corporate Announcements—there may be company meetings, corporate announcements, customer presentations and the like, in which a group of participants may wish to share viewpoints, while watching the corporate announcement.

News and Journalism—news events from all around the world occasionally turn into the “talk-of-the-day.” Many of the news events are of public interest. People would like to discuss, debate, and respond within groups, while watching the news. Many other examples are applicable to the methods and systems of the present disclosure, such as, but not limited to, fashion shows and family events, in which a group participates in specific video content in real-time.

Embodiments disclosed herein allow multiple users to see the same program, and on the same screen, may see each other live, thus creating a unique viewing experience, that is enhanced by users viewing themselves virtually attending an event with an atmosphere, as reminiscent as possible, of the event atmosphere of a live-audience movie theater or stadium.

The present disclosure provides a method and system for enabling the projection of information obtained from a camera and a microphone of each of several users, each located at different locations, onto their device screens as PIP (picture in picture) with synchronization of the content on which the images are projected, between all the screens so all members of group are watching exactly the same program in the same timing. Additional extensions enhance the viewing experience of all the remote users and communication there-between. In other words, the systems and methods of the present disclosure create 3 layers, namely, video on top of each other on the same screen, 1) the program/video content, 2) a template of the event location, such as a theater and 3) a video conference in which the participants mainly watch the program together, but have the opportunity to communicate with each other. Different from regular video conference, the system places the members on the seats, and the places the result of these 2 layers (members on seats,) on the video content. A fourth layer will sometimes be needed, to add body parts and other elements as well, as explained below.

The systems and methods of the present disclosure provide a virtual image projected onto at least one device screen, in which remotely dispersed participants/users are viewed as being on chairs or armchairs at one location, reminiscent of watching an event in a cinema hall, concert, or stadium, depending on the nature of the event/program. The systems and methods of the present disclosure further provide an option for event participants to change their virtual positions and transparency in real-time on the at least one device screen, to prevent disruption to the event/program.

In this disclosure, whenever the term “movie” or “film” or “video” is mentioned, it should also be extended to a sports event and to any program seen (watched) by a number of on-line viewers unless explicitly stated otherwise, and of course, with the required changes. Whenever the term “theater” or “hall” is mentioned, it should also be extended to “stadium”, and to all sorts of places indoors or outdoors where a live program may be watched or seen. The terms “he” and “him” are meant to cover both masculine and feminine persons.

The systems and methods of the present disclosure further provide a remote user with an experience of a live movie in a movie theater, such as, starting few minutes before the movie screening begins, until the end of screening and the audience leaves the hall. All this is provided by using the same event participants, who watch the event/program, synchronized from many remote locations at the same time.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein, and should not be considered limiting in any way. In the drawings:

FIG. 1A is a simplified block diagram of a system for three-layered content viewing, in accordance with an embodiment of the present disclosure;

FIG. 1B is a simplified block diagram of a method for three-layered content viewing, in accordance with an embodiment of the present disclosure;

FIG. 2 is a simplified flow chart of a method for three-layered content viewing, describing some of the actions that take place in the server after an invitation from the host to watch a movie from catalog of that server as shared viewing being sent, in accordance with an embodiment of the present disclosure;

FIG. 3 is a simplified screen shot of an output of the method of FIG. 2, describing one possible framework for many kinds of shared viewing, in accordance with an embodiment of the present disclosure;

FIG. 4 is a simplified illustration showing a method for seating an individual user inside a virtual movie theater, in accordance with an embodiment of the present disclosure;

FIG. 5 is a simplified illustration showing the interaction between movement performed by the individual user's head and translation of these movements onto a screen showing the virtual cinema space, in accordance with an embodiment of the present disclosure;

FIG. 6 is a simplified illustration showing different options of location for a football stadium audience, in accordance with an embodiment of the present disclosure;

FIG. 7 is a simplified illustration showing illustrates the possibility of dual-screen use in some embodiments, in accordance with an embodiment of the present disclosure;

FIG. 8 illustrates two options of positioning the audience in the same scene, once in foreground and once in background, in accordance with an embodiment of the present disclosure;

FIG. 9 illustrates an advanced possibility of reaction of the system corresponding to camera movements in the content- translated into camera movements across users, in accordance with an embodiment of the present disclosure; and

FIG. 10 is a simplified flow chart of a method for manipulating display content, in accordance with an embodiment of the present disclosure.

### DETAILED DESCRIPTION

In the following detailed description, numerous specific details are set forth in order to provide a thorough understanding. However, it will be understood by those skilled in the art that the presently disclosed subject matter may be practiced without these specific details. In other instances, well-known methods have not been described in detail so as not to obscure the presently disclosed subject matter.

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

The term “processing unit” as disclosed herein should be broadly construed to include any kind of electronic device with data processing circuitry, which includes for example a computer processing device operatively connected to a computer memory (e.g. digital signal processor (DSP), a microcontroller, a field programmable gate array (FPGA), an application specific integrated circuit (ASIC), etc.) capable of executing various data processing operations.

Furthermore, for the sake of clarity the term “substantially” is used herein to imply the possibility of variations in values within an acceptable range. According to one example, the term “substantially” used herein should be interpreted to imply possible variation of up to 10% over or under any specified value. According to another example, the term “substantially” used herein should be interpreted to imply possible variation of up to 5% over or under any specified value. According to a further example, the term “substantially” used herein should be interpreted to imply possible variation of up to 2.5% over or under any specified value.

The disclosure uses the term “AYAS” to methods and systems related to any broadcast of a show whether on smart TV or computer or mobile phone, including, but not limited to, online movies, social games on TV, soccer or basketball, concert, theater show, rock concert, athletics, all other sports.

Each time the term “computer” appears herein, unless otherwise stated, it means also any other device with operating system or with computing power like smart TV, cell phone, tablet and the like.

The viewing experience is not limited to movies alone. AYAS supports any type of show whether streaming, simultaneous projection, on line screening, and television or streaming of any event that has an audience watching it. For example, some non-limiting examples of uses of the methods and systems of the present disclosure include sports shows, like football games, speeches, theater, circus and the like. For purpose of illustration, a cinema hall (movie theater) is used to exemplify a stadium, theater, circus tent, concert hall, outdoor street show or any other event. All of these event locations are part of the application of the AYAS disclosure.

In some embodiments, installing AYAS on a smart TV works as follows: AYAS installation identifies all the applications installed on the same TV that aim to receive live TV broadcasts and TV channels Via the Internet such as: CNN, ABC, NBC, FRANCE TV, USA TV, Live sports channels etc. It attaches the same channels to the list of possible content to share. In such a case, with the activation of AYAS by the host (as by any user) among the other content to be shared, in addition to VOD, the content on the server, to YouTube, Twitch and his own videos on the TV hard disc, he can share with his friends a shared viewing, AYAS, of these TV channels.

For example, the host chooses from AYAS catalogue an app of a TV sports channel that broadcasts a direct football game. He sends an invitation (one click) to his pre-defined group of friends (members). Each of them receives an invitation. A confirmation adds this member into the virtual stadium seats. If the same app of that specific sports channel is not installed by the member, the system detects it and sends him the link to download the app.

In other embodiments, there is no need to send the order through AYAS. The order is sent through a dedicated button on the TV remote control called AYAS. Any viewing of a TV channel on the smart TV through an app, from the Internet allows the host, by pressing the AYAS button on the remote control, to send an invitation to his pre-defined group of friends, or to all his contacts, or add more guests as he pleases. Of course, anyone that installed AYAS can become a host.

In other embodiments, these halls or stadiums are automatically uploaded, in accordance with/responsive to the type of program and the audience size. For example, if a user choses to watch a live basketball game, he is not directed to sitting in a movie theatre, but rather in a basketball hall.

In some embodiments, the viewer is be able to download different types of location designs, according to his/her individual preference/taste for event locations, such as halls or stadiums. For example, if the user wants to see a football competition and wants to feel that he is in Wembley Stadium in London, he may do it, and the virtual viewers is placed in the stadium stands. Additionally or alternatively, if he wishes to view an opera and feel as if he is sitting in the Vienna Opera House, he may do so, and the audience watching the broadcast is located at the same venue. The catalog of halls, stadiums and viewing sites may be limited. Thus, a specific user's choice is only affect his viewing experience, but is not affect other users' venue preference. Thus, each user is free to set his/her viewing experience and virtual venue preference for him/her self.

In some embodiments, all the virtual body parts added to the participant to create the feeling of a body sitting in the theater, are Layer 4 in addition to the 3 layers (the content, the virtual seats, and the participants as their video is sent by their camera).

According to some embodiments of the present disclosure, AYAS is not only applicable to shows in which a live audience participates, but is also configured to provide a new user experience and alternative for common viewing experiences for all television broadcasts in the world. The systems and methods of the present disclosure enable any TV viewer to have the option to install or/and connect to AYAS.

Accordingly, virtual, imaginary halls are provided, in which viewers of the same plan of objects are merged to enable a shared viewing experience. By using AYAS, a news program receives its own venue, such as a screening room under the circumstances listed herein and a user finds himself watching the news with another ten people, a hundred people, or a thousand people and is able to view and read their reactions, their expressions, their body language, etc.

To make it easier to read and to simplify things, I chose to use the concepts of a cinema viewing experience and of movie theater, but for the sake of caution I mean that every time I use this term, it refers to the viewing experience as defined above, with all its broad possibilities, far beyond cinema, each time more than one audience watches together a program. So, for example, when the term theater is used, it may be also mean stadium etc. Similarly, use of the word “movie” or “film” may be extended to a football game, showing a theater program on television live concert, etc.

In some embodiments, when installing AYAS, the user is asked to list his gender, age, height, and body structure and his quality stills. He is asked to save and upload few stills photo of himself, at different angles or to photo himself according to instructions that are provided to him by AYAS. Other data of the user behavior is provided by the user's camera during the projection.

According to one embodiment of the disclosure, the user is able to add these data later during the session.

According to one embodiment, the central computer takes some of the data processing tasks in addition to its direct broadcasting of the film or program.

In some embodiments, there is a combination of computing power between the user's computer and the central computer (the server) in order to maximize the process.

In some embodiments, the central computer is given the option of transmitting regular television broadcasts of various broadcast channels, including but not limited to, reality shows, sports programs, entertainment programs, feature films and documentaries, live concerts, (either rock or classic music), and commercials, the user has the opportunity to switch to a shared viewing experience.

In some embodiments, AYAS is installed on the smart TV.

In some embodiments, AYAS is an embedded part of the computer or the smart TV.

A user who enters a screening at home, and runs AYAS, after choosing the type of movie theater, buys a ticket at the virtual box office, buys himself a popcorn or drink, and then presses an entrance button, before the movie begins, the other users see him walk into the movie theater (while the lights are still on). He enters through the doorway and sits down in place according to the ticket he bought.

In some embodiments, the movement of the user from the front door of the theater to his seat, as well as the exit at the end of the screening, is purely virtual.

In some embodiments, all AYAS functions is on the smart TV without the need of any other device. The smart TV, or one of its channel, is show the program (live or not live) and the AYAS installed on the smart TV is allow the user via its remote control or touch screen or voice command to function and to have all the possibilities of AYAS. The TV is equipped with a camera. In case the TV is not equipped with a camera, the user is able to use the camera embedded on the computer or mobile phone having installed AYAS, or any other camera having WiFi or Bluetooth, so that the information from that camera is the one that appears in the hall, the stadium etc. and represent him

In some embodiments, the movement of the user from the front door of the hall to his seat, as well as the exit at the end of the screening, is partly virtual. The track from the door to every chair in the hall is pre-programmed, but is still be in the form of elements taken from the real character: character of the real character; the color of the shirt; the structure of the interior;

hair color; height of the figure; body structure.

The movement of people from the door to their place is consist of the information given in advance. This first step is require collaboration with existing graphic programs that “builds” the head on a pre-programmed body.

The size and type of the movie theater is supplied after receiving an estimate number of viewers expected and data of the number of viewers in the cinema theatre available for selection, e.g. theater hall style (like theater hall of the 50′, Modern theater, Futuristic cinema hall), style of the seats, screen, walls, hall.

In some embodiments, in the virtual ticket box the user is buy or get a single ticket and indicate the number and names of people he wants to sit beside him, or to be a part of his group and whether he wants this group to be the only viewers in the hall or stadium, watching this program, or he is willing to have additional audience, randomly or by types like age, country, sex, etc.

In some embodiments, the user is able to create a group consisting of for ex. 3, 5. 10. 100 people that in each event they get a message to watch with him. He may decide that this is the only people he wants to see as public.

In some embodiments, the user is able to create a few types of groups, for example sport groups, movies groups, rock groups, classical talk show groups and news groups, etc.

In some embodiments, the user is able to choose if he wants to watch the movie exactly from the line and chair of his ticket, (for example line 3 chair 1, a very close and left position) or choose to watch it from the optimal position of the hall. This does not change his position on the chair as viewed by other users in the session. The user is asked to allow the computer camera to see him sitting at full height. Then he is asked to turn around and show his back and neck to the camera. On the basis of this data, AYAS is compile the audience in the photos behind. If a user fails to do so, AYAS has the option of assembling the appearance of his back and neck in an approximate manner using the data of his frontal image coming from the computer camera.

In some embodiments, users are able to switch during the screening to several angles. In common with all these angles that the users see, along with the film, the viewers, whether in the preview, and especially in retrospect, just as they are accustomed to “feeling” the viewers around users in the hall, When AYAS assembles them from those real viewers who watch the movie with a user at that moment. The front camera angle is then seeing the audience not with their back to users as normally in the hall, but sees their faces as if a user is standing near the screen and watching the hall. In this case, AYAS “sits” a user virtually on every chair in the cinema with the necessary adjustments, but the viewer's response to the film is a live response taken from the direct broadcast of his camera.

For example: if there is a funny joke in the movie, and the user at home is laughing, his character in the hall sitting with 200 people is laughing too. The body movement is taken from his body movement and the audio of his laugh is taken from his microphone. In other words, AYAS accounts for the viewers' camera data, that they are well positioned in the movie theater armchair, but their responses to the movie is live every moment according to their live data received from their cameras.

In some embodiments, lack of information is compensated by subtle and invisible connection between the body and the head. The body as recorded in the previous data and the head as it being transmitted in the live broadcast. In the absence of previous data, AYAS creates the body itself based on the data supplied by the user.

In some embodiments, the user is able to choose the screen size of the hall. Starting with the option of a full screen without any audience, through a gradual shift in several steps, each stage shows more audience and the screen gets smaller. The last choice is of the entire cinema hall with all the top-notch viewers and is also be another angle from the view of the film's projector.

In some embodiments, a viewer who prefers to close his camera, AYAS use that viewer's buffer as taken until it is closed. In case there is no such thing, the program creates a virtual character.

In some embodiments, by clicking on the image of another viewer from the audience, it is bring him to full screen, provided it gave it permission before the screening to such an act.

In some embodiments, if a viewer decides to leave an event, the other users see him leave his chair and theatre. He has the option to cancel the function that shows him leaving, and then AYAS wipes him out of his chair without restoration and the chair is remain empty by dissolving his image to provide an image of an empty chair.

A user is able to notify AYAS that he is leaving for a short time, and then his character is frozen, (still frame) until he comes back.

In some embodiments, the user is able to select multiple levels of interruption during playback. From a quiet, silent crowd to a raucous crowd. Users are able to leave the microphones open while watching and depending on the degree of interference selected, the audio responses is filtered into the overall soundtrack. The disturbance also includes people arriving late and passing the user and briefly hiding the screen. All according to the user's choice and according to the level of nostalgia and desire to experience the cinema experience on all its paths.

In some embodiments, each user's computer or smart TV is use its own independent computing power to process and provide the user with the desired screen and audio, after processing the information sent from the other participants, and from its own computer.

According to another implement, the projection computer, the computer or the station which transmit the film or program (“the central computer”) undertakes all the processing tasks in addition to its direct transmission of the film.

In some embodiments, there may be a combination of using the computing power of both the user's computer or TV and the central computer in order to supply the user the desire image and sound.

In some embodiments, the user is able to report in writing or audio or by symbols what they feel about what is happening on the screen or communicate with one another.

In some embodiments, each user's computer or smart TV uses its own independent computing power to process and provide the desired screen, after processing the information sent from the other participants, together with the information from its own camera.

In some embodiments, in case of smart TV, this work of computing power doesne by the set top box.

In some embodiments, the computing power is split between the CPU of the TV, the set top box, the PC and the central computer (server)

In some embodiments, in the case of trivia programs for example, the opportunity for the user to participate in solving some of the questions is either by writing a reply or by “bouncing” his image to the center so that he answers the question online.

In some embodiments, the transmitting television station or channel takes on all the functions of the central computer.

In some embodiments, one way to encourage the user to connect his camera would be to see himself among all viewers, sit in a row and seat he purchased before the screening, respond to the movie as he chooses to respond.

In some embodiments, instead of film and movie theater, the user may choose a sports program including football, rugby, basketball etc., and then watch as a spectator in the stadium where the competition is held. In that case, and because most sports competitions are held in front of a real crowd, the stadium provides an offer of virtual bidding for seats where the virtual audience is seated.

In some embodiments, in case the stadium is empty the user is able to choose between the real stadium and a virtual one. When one says virtual, it is only the stadium or hall. The people are real and live, in their homes.

In some embodiments, the camera may be locates in front of groups of people, for example in pub where people are watching a live football game. In this case, AYAS will allocate to this group a special place like a special tribune.

In some embodiments, the audience in the virtual stadium for sports shows is composed solely of viewers of AYAS without including the audience in the stadium.

In some embodiments, while playing in an empty stadium, a view of the stadium is transmitted onto the huge screen and huge speakers in the stadium, the images coming from AYAS to give the players the ambiance of game in front of people.

In some embodiments, the user is able to buy multiple tickets, or alternatively get more than one seat next to him In this case, if the user positions himself so that the camera capture more than one viewer while watching, AYAS knows to arrange him/her and the other person or persons next to him in the theater seats.

In some embodiments, by clicking on the back or front (in the case of a screen showing the viewers from the front) of a character sitting in the hall, the user is able to get her or his name and other details as agreed by the other user.

In some embodiments, by double-clicking allows the user to open a dialog box with the same character during the session.

In some embodiments, one may create a set of viewers that may assemble from anyone who comes to mind, including friends, or viewers one sees on AYAS, say, in a concert. For example, one may press the P key when the mouse is placed on a nice, blonde viewer and she is immediately offered by the user the opportunity to join a viewing group of the user. One may define what type of group to which to belong. Sometimes, before starting such a program, each user receives a reminder and invitation through the AYAS. Some may save places near the user.

Of course, one can, at the same time as one invites others, to have a conversation with them through the AYAS dialog box to let them see the user, and let the user see if he/she did not make a mistake about the invitee.

Other interfaces such as Facebook or WhatsApp also have the option of directly communicating with AYAS so one can, for example at the click of a button, turn entire groups from social sites into shared viewing groups.

In some embodiments, by pressing one of the keys one may receive a complete list of viewers in the session.

In some embodiments, a viewer may request in the dialog box, when buying a ticket, that it be anonymous and his name should not appear on the list.

In some embodiments, by pressing a button, it allows the user to hear the audio at home as close as possible to the sensation as in the movie theater, by mixing in different levels the audio of the other users.

As a secondary use of AYAS, it may be applied, (like in reality when a user left his home and went to theater) as an opportunity to get to know new people. The user can, at registration or later, enter additional pictures and information about himself of his choice. He may allow other viewers to view them by clicking on his image at the screening and opening dialog window. The screening organizers, or the private organizer who called the group, and at the same time any user, may restrict these referrals and calls, only to before the screening, during breaks and after the screening to prevent screening interruptions.

In one embodiment, AYAS uses the technology, created by other program such as VEGAS, MOCHA, ADOBE, Zoom, etc., which enables tracking and graphical manipulation.

In some embodiments, the only part in which virtual characters are used is the part where people come to the seat or leave, or to get near a friend.

In some embodiments, these passages of virtual characters is pre-programmed, and is use animation after the user presses “ENTER” to enter the theater.

Definition: The word “back” refers to the sight of the spectator sitting in the theatre as seen by someone sitting behind him It mainly includes a user's head, neck and small part of his back.

In some embodiments, AYAS is used as a source of the back of the user as provided by the user.

In some embodiments in the absence of such a data of back, AYAS creates a back image based on his front image. The movements of the back may, of course, be in reverse based on the front camera live data. Right-to-left movement and interpreted as left-to-right movement.

In some embodiments, the user is able to change the trim and color of his clothing and especially the visible ones (upper).

In some embodiments, the user may only select one movie theater or one stadium.

In some embodiments, the row and chair that the user purchases, is the fixed place for all screenings or games in the same theater or stadium.

In some embodiments, the user is given a place either at his choice or in accordance with the existing seats available.

In some embodiments, the seats available at the ticket box are sold in such an order that an imaginary rectangle is created between the screen and the hall. Only after the rectangle is completed, are additional tickets sold.

In some embodiments, in cases the user's camera only provides his head, like in case of close up, the system is configured to do all the processing work that is intended to put the user's head as received from the camera on a virtual body, to create an impression of an entire user's body, sitting on a chair, and/or any other required graphic manipulation.

In some embodiments, AYAS adjusts lighting and brightness and color to balance the images of all members who naturally are in different places with different lightning conditions, to create the ambiance that they are in the same place (theater, stadium, etc.) under the same lightning conditions.

In some embodiments each user's computer transmits an image as it fully or partly is “processed” by AYAS, but not the full original image.

In some embodiments, the user has the option to provide AYAS a still image instead of the camera image provided live.

In some embodiments, the user is able to shake this still image or to add some built in by AYAS movement to express his emotions in a given moment of the program or to distort it or to enlarge it, combined with audio effects. If the user did not provide his/her body image sitting (so one may see his entire upper half), AYAS provides a virtual body. In this case, the user is able to choose the type of this body and for example color of his top clothes.

In some embodiments, if there is no real match between the virtual and real character, or each time there is a virtual part, AYAS has the option to add either if one sees the person close or if one clicks on it, something like “It is not the real me”.

In some embodiments, in the case of multi-participant screening AYAS, out of CPU power calculations, it ignores the people sitting in the front rows (or back, depends on angle) that may hardly be seen, and instead, these characters are provided by AYAS as pre-created virtual ones.

In some embodiments, only disappearances, and shutdowns are received as a response to a virtual character leaving. In some embodiments incidentally, a viewer who decides to switch off, is disconnected or leaves the camera and his image is seen coming out of the theater. If he decides to return, his character is returned to his seat.

In some embodiments, when the user installs AYAS, he installs all the possible theatres, stadiums etc.

In some embodiments, the user is able to send another user present in the theater, a double click message: “Look at me. I am waving my hand.” It is possible to lift both the hand and the head (if he or she sits in the back) in both the real (half body photographed) and virtual form.

In some embodiments, there is some movement of the body for the user to choose, which he does not have to do himself with his body, but AYAS does it in his place. For example, waving his hand to say hello, throwing a popcorn, etc.

In some embodiments, the degree of disturbance that the user selects navigates a mix between the soundtrack of the movie and the noise of the audience according to the degree of the selected disorder.

In some embodiments, the degree of disturbance that the user selects affects the time when people who come into their seats in the user's line hide the user screen or the entire hall or the intensity of the popcorn thrown at him

In some embodiments, the user chooses the direction and distance of the popcorn he intends to throw.

In some embodiments, all these disturbances are stopped when the film starts.

In some embodiments, the user is asked to take a photo of himself on a green background or any other color that is allows AYAS to work optimally either by key, mask etc.

In some embodiments, the user himself makes various adjustments to facilitate AYAS on the one hand, in order that his character is get the best match in terms of the size of head and body size and the like, to closely reflect reality, and to give the user's image additional qualities according to his taste.

In some embodiments, each user is responsible for ensuring that his or her image is placed in the seat most closely to reality by means of adjusting it and correcting and maximizing the reality effect.

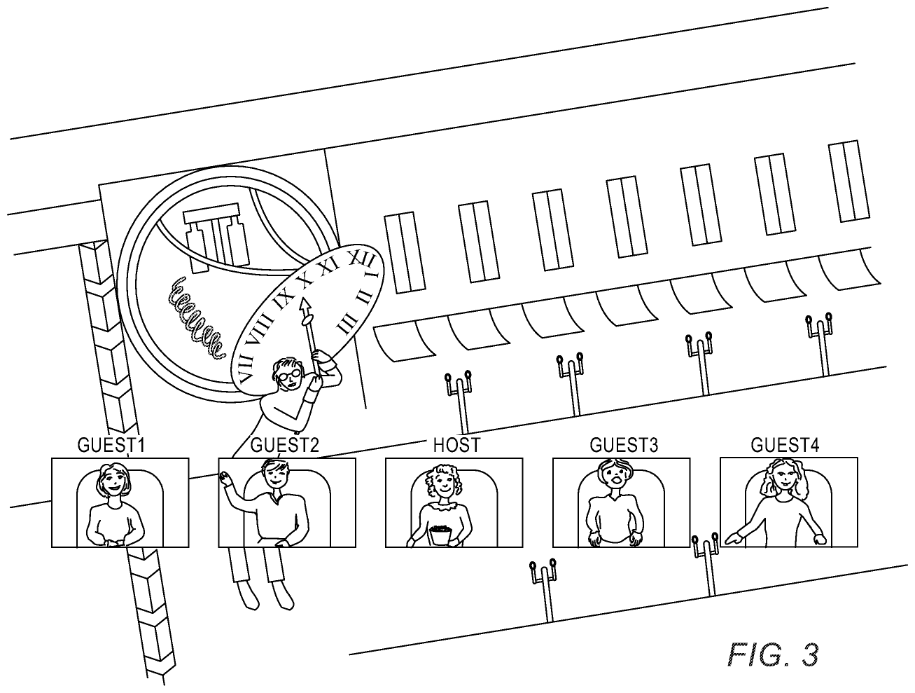

In some embodiments, the user is able to select a hall image from the side, as shown in FIG. 3.

In some embodiments, AYAS chooses people whom the camera views from the side or profile, for example, people who watch the program on TV but using the computer camera.

In some embodiments, the user is able to perform a pan operation and panorama to see the audience aside and back reminiscent of a spectator sitting in place in the theater or stadium, and slowly turning his head sideways and then backwards to see his friends or enemies.

According to another embodiment, the user's computer sends out all the necessary channels, meaning that his image is on the different screens located accordingly and each additional user selects the desired screen at any time.

In some embodiments the organizer (that is, the one who called the group to see together the program) decides alone about the type of hall or stadium, in which all the group is seen.

According to another embodiment, the central computer performs image processing operations after receiving the necessary information from each user and processes it together with live pictures received from each user.

In some embodiments, only smart TV is used, to process between the information coming from the program, the broadcast (film, sport etc.) and the information coming from AYAS.

In some embodiments, the user may, before or during the program, select a set of users, or call one or more users, whether online or offline, or choose among those who are viewing the program, to watch in AYAS as a group as a selected group.

According to another embodiment, if this user was not installed, he may be asked to be installed right away. The host is able to use groups from other social media. For example, he may ask all his Facebook or WhatsApp friends in the group to join him watching the film. In this case, an option of a standard message is provided by AYAS. In other words, AYAS is constructed and configured to send message to everybody in a selected group, before the program starts and/or during the program, announcing the program and proposing to other users to watch the program with him AYAS allows the other users to confirm and log in immediately.

In some embodiments, to allow user to share his feelings, artificial intelligence will decipher his face and body language, and a cartoon artificial creature will get the same feeling. For example, if the user is sad, the cartoon creature will shed a tear, it will rise for a few seconds above the user's window, to inform and share with members of the group what he feels in front of the scene.

In some embodiments, if users did not install AYAS on their device, they receive a message to identify it and advises them to install AYAS.

In some embodiments, the user who called his friends is able to place them in the various seats at an event location.

In some embodiments, the user is able to place himself in various seats at an event location.

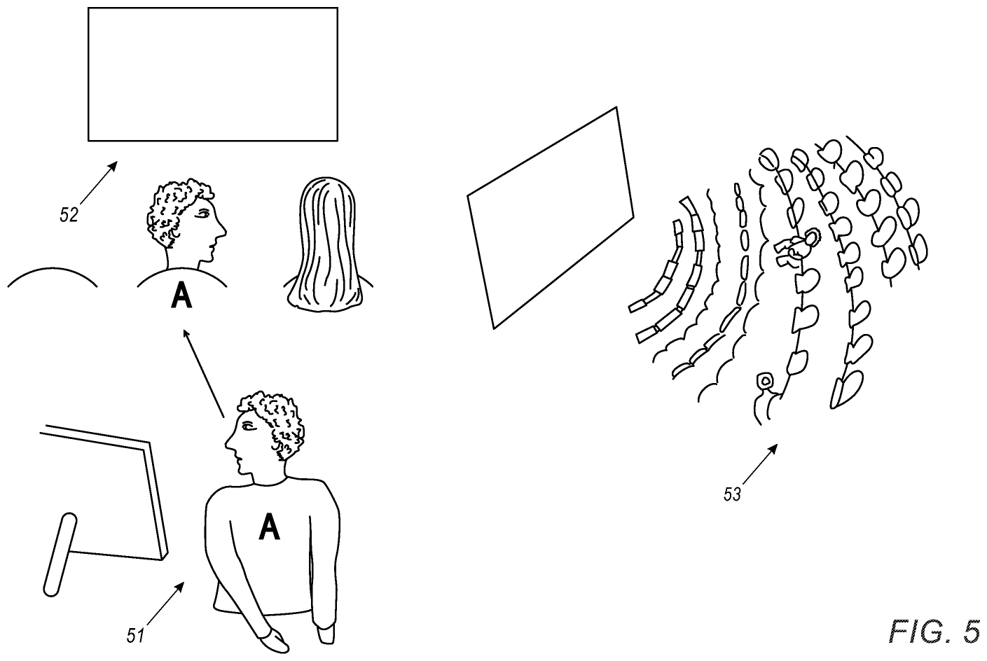

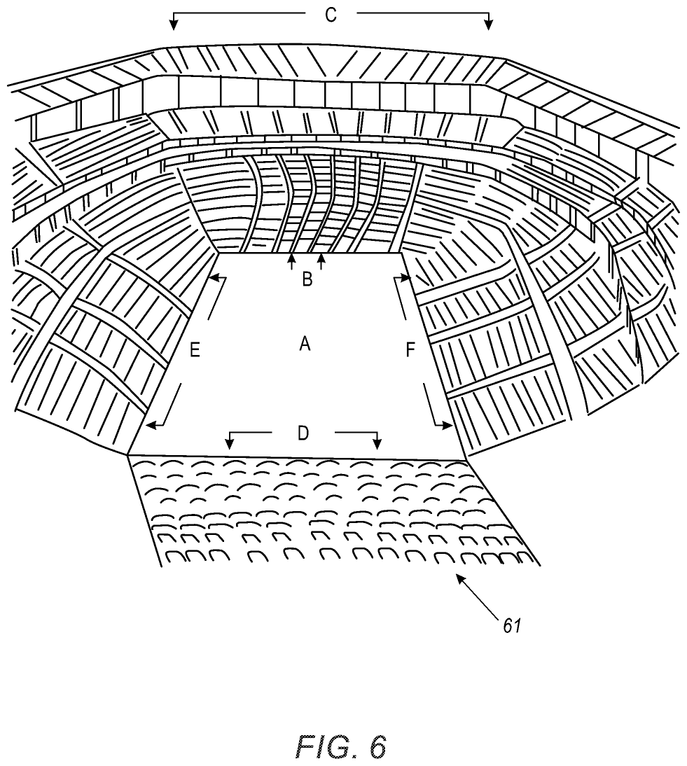

In some embodiments, the user may use a number of screens to split and separate the event (movie or sports program) from the user screen as illustrated in FIGS. 5 and 6. For example, he is able to watch a soccer game on smart TV and watch the viewer offers on a computer screen or on a mobile phone. Alternatively, he can watch a game on his mobile phone or computer screen and watch the participants on his smart TV.

The drawings illustrate several only limited possible forms of group arrangement at the time of viewing. In some embodiments, it only applies to smart TV.

In some embodiments, collaboration with companies such as Zoom may be added, and their source code is supplemented with any required further code to support/seamlessly work with AYAS.

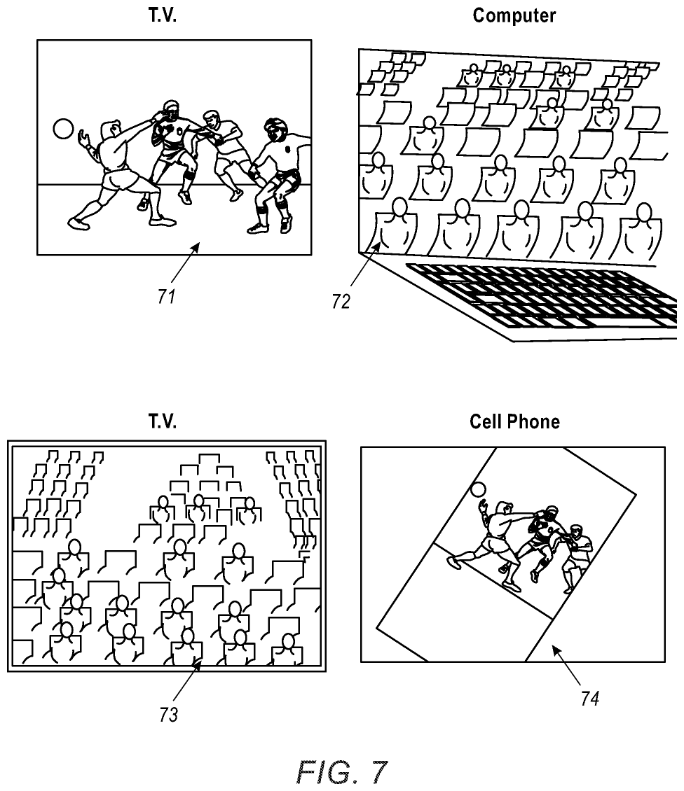

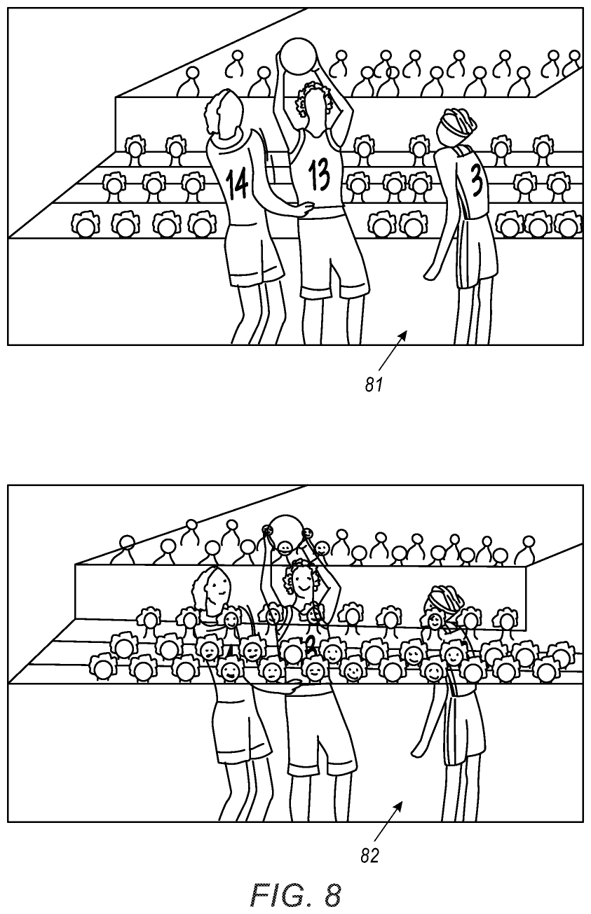

In some embodiments, in the event that an on-screen event is covered/overlaps/hidden by the virtual audience, the user may be enabled to decide who hides whom, whether players hide the audience or the audience hide the players as illustrated in FIGS. 7 and 8.

In some embodiments, a user may “approach” another user and perform various actions with him such as using his hand to shake some radiant pop or cold juice. For this first step, he has to move away from the camera to get the space required to move within the frame, and while looking at the frame he may decide who he is addressing.

In some embodiments, such an “injury” to another user is result in this “injured” user's consequences of changing shape or sound: for example, the “injured” user is turned into black and white. He may be turned red and/or his character is distorted/changed/moved, become a funny cartoon character, or shout in funny voice and the like.

In some embodiments, instead of accessing the user, he may throw a beam of popcorn. He notifies AYAS who he intends to target (username) and AYAS knows, based on his shot direction and power whether the targeted user was hit or not. AYAS or the user decides which kind of response is provided, whether a sound or image, or combinations thereof, is created.

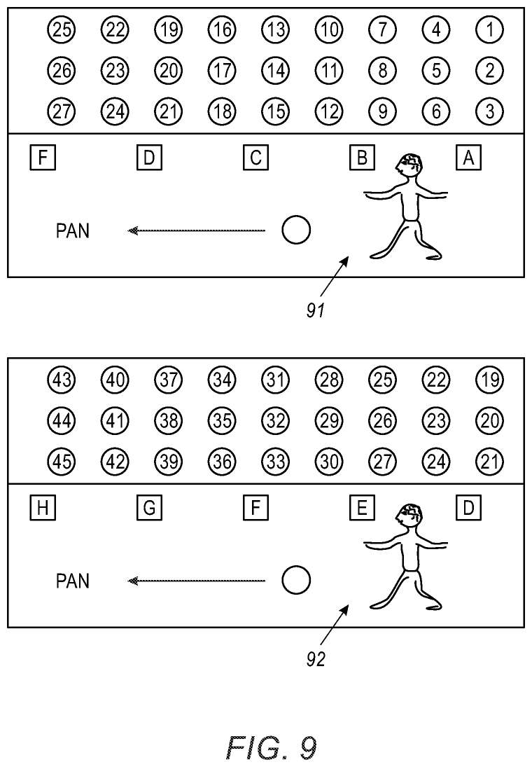

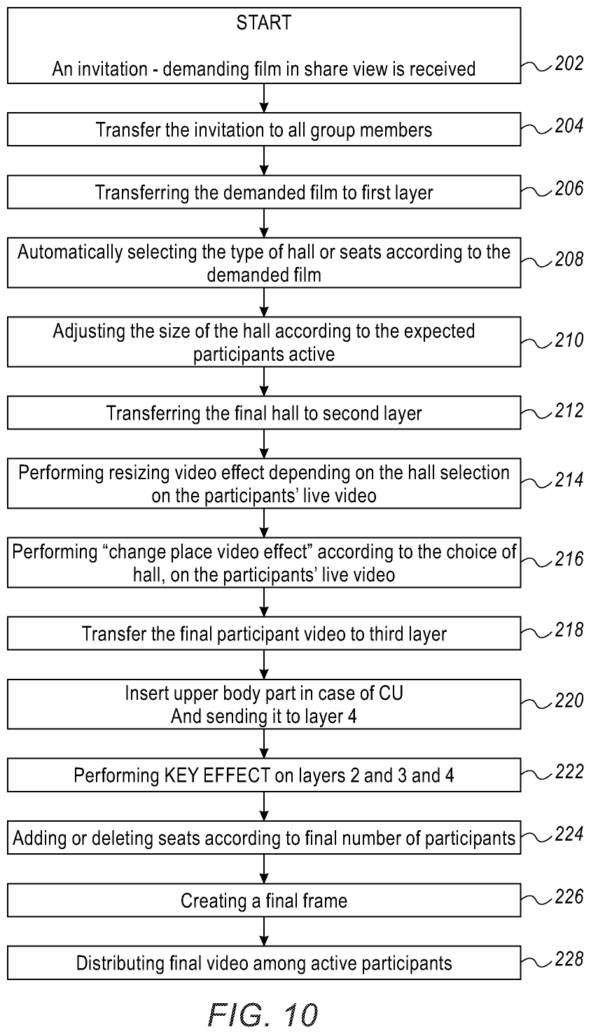

In some embodiments, relating to sports programs like basketball, but not only, the user is able to program AYAS so that the seats of the audience are not fixed within the frame, but is move relative to the camera movement of the game. For example, in cases where the team moves a ball from the right edge of the field to the left edge, if the audience's seats are located in front of certain users, when the ball or player moves from right to left and the camera pans after him, the same pan with the same speed is made to the certain users' AYAS audience, all to give these users the illusion that they is in a real game- see FIGS. 9 and 10.

In some embodiments, the audience appears in a masked effect or in a main effect. That is, a user's body shape is cut from the background of the room he is in.

In some embodiments, the user is not cut from the background in which he is present, but he appears as a rectangle.

In some embodiments, the audience is appear in a crop effect, which means the stands appears as a slot.

In some embodiments, the user determines who is hiding whom. For example, the player hides the audience or the audience hides the players, as shown in FIGS.? and 8.

In some embodiments, the camera is located on the smart TV.

In some embodiments, in cases in which the camera is horizontally disposed (sideways) and the user looks from the side, for example, the camera is located on the computer but he himself watches the game on TV, AYAS places him in the side seat so that his head movements and facial expression are as if watching the show, movie or game from the same angle.

Last but not least, in some embodiments the user is able to buy popcorn before entering the hall. AYAS allows him to finish eating within the time set by him in advance and with a noise level as average of what he would define and as his neighbors would define according to the “disruption” level.

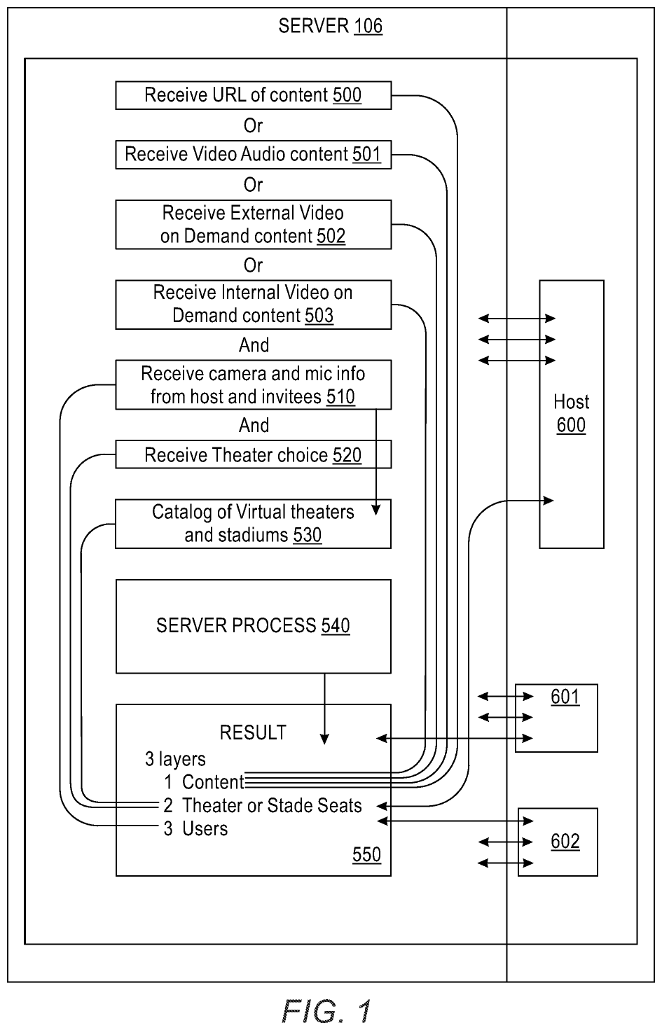

Returning now to the drawings, FIG. 1B shows a block diagram illustrating an exemplary system of the present disclosure, performed by the AYAS server 106. The server receives a shared screening invitation from a host 600. The order includes a live URL (uniform resource locator) 500. This URL may be an Internet TV station, live broadcast on YouTube or any other live program. In this case, the server is able to perform two actions—either pass the URL to the participants as part of the invitation, or converts the URL into video and sends the participants the video itself. It may receive a physical video 501 from the host and broadcast it. It is constructed and configured to obtain external VOD 502 such as Netflix or Amazon. It (the AYAS server) may get a VOD demand for movies on the server itself 503.

In addition, it receives 510 from the host and the other 601 and 602 participant information that includes the camera image and the sound from their microphone as well as various data that is later help synchronize between all the systems.

Depending on the nature of the program being broadcast or the choice of the host, he chooses 520 from the 530 catalog the desired form of theater. It processes all data 540 to create new video 550 that contains these three layers and distributes it among participants 600 601 and 602.

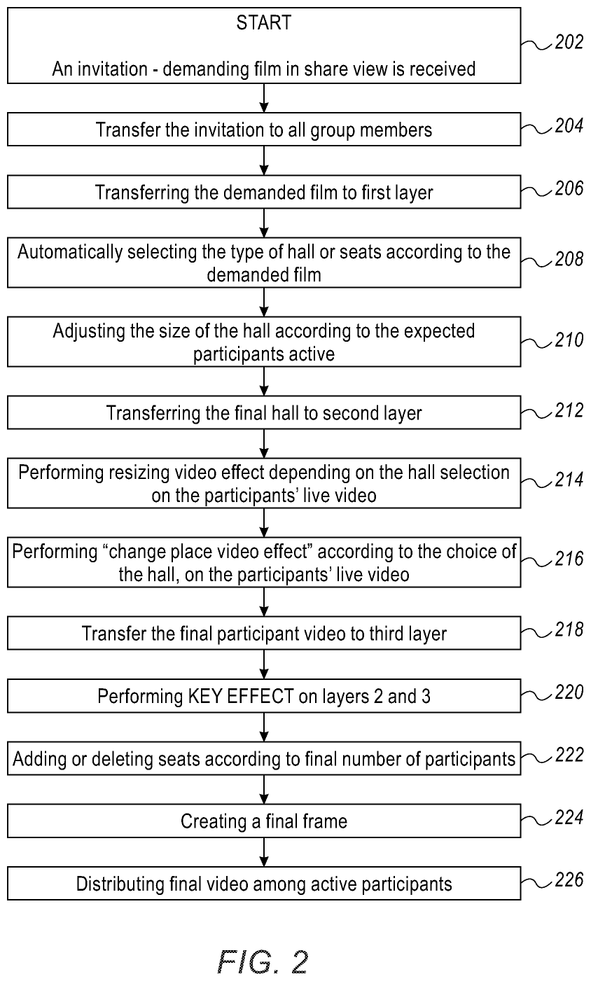

FIG. 2 a simplified flow chart of a method for three-layered content viewing and describes a process disclosed herein, in which an invitation for demanded film in share view and some of the actions that take place in the server after an invitation from the host to watch a movie from catalog of that server as shared viewing being sent.

The invitation is sent 202 to the server by a member of share view group. From that moment he becomes the host. Upon receipt of the invitation on the server, it is immediately distributed 204 to all members of the group. The invitation has the name of the host, name of the film and an indication of whether the screening has already begun, or begins at a certain time. At the same time, due to the choice of the host, chosen (demanded) movie (VOD) is 206 transferred from the database stored on the server to the first layer. It does not need to go through any visual effect or image manipulation, unlike the visual information that is reach the other two layers two and three.

The action of the layers is now elaborated. In order to get a final picture showing the whole group of friends who decided to watch the movie, sitting on cinema-like seats, seeing each other and responding to the live movie that is synchronized between all its members, although they may be in fact in different parts of the world, a combined action must be performed on the server (or on any device among the group members). This action involves digital visual effects, motion graphics, and compositing and it does it by an application installed on the server (and/ or in other cases, on the participants' devices).

This application knows how to receive several video or still image channels and handle them as required. Such applications have been on the market for over 25 years and undergoing updating all the time. In fact every time one make a video conference call, the video of the participants go through a similar app in order to be scaled down, and arrange participants side by side. This is responsible for the effect of reducing the image and arranging it to continue in the right place.

KEY effect

The KEY effect exists and is available to all. “Zoom” software, for example, that allows without difficulty to change the background behind the user uses such an effect. In the past the requirements for making the effect were that behind the object there is a blue background. It is called Chroma Key. Chroma key compositing, or Chroma keying, is a visual-effects for compositing (layering) two images or video streams together based on color hues (Chroma range). Today, the requirements have become much more flexible. The program knows how to identify the user's body characters, and change the background behind it for any background one choose. Without this effect one will have no feeling that the person is sitting inside the cinema hall or stadium because the background behind it is visible. It is necessary to “clean” it from the background as much as possible and sit it as it is on the seat.

In the present case three image channels is needed. One channel (Layer 1) is the channel of the film that does not require any visual treatment. The second channel (Layer 2) is the hall channel. The hall is reach this layer after passing through the video channel as detailed. This channel also needs to undergo a KEY effect because it is supposed to be laid on top of the film as picture in picture. The third channel (Layer 3) is the channel of the participants.

Back to FIG. 2, the host's camera transmits its image to server 200 and it is received on server at 202 due to the invitation sent to the group joining guests 204 and 206 and due to their joining, their camera transmits their video image to the server. But the server is still not ready to handle these images because before that it needs to know which theater hall has been selected. 208. How this choice being made? It may be automated according to the type of film and its genre and the number of participants, and may be manually by the host as part of the invitation or as a separate message to the server. The seats are likely to be located at the bottom of the image but the host may change this to anywhere in the image. In some embodiments of the disclosure, the program is able to identify the part of the image that is least “interfering” with viewing, and place the seats there. The users may control the transparency of both the hall and the participants if they do feel disturbed.

Within the catalog of halls and stadiums there is a large selection of templates. In step 208, after selecting the theater type, the selected template is sent to the effects department. It has to go through a visual effect and is not sent as it is to the layer. This for two reasons: 1) it has to be adjusted to its size according to the actual number of participants in the screening; 2) it has to go through KEY effect because it is supposed to be in the final frame 250 as image on image.

The template undergoes a resizing 210 depending on the number of participants and then it moves in step 212 to create Layer 2 before key effect. Only now, the system is available to take care of participants.

In some embodiments, steps 214 and 216 are performed together. The system knows in its settings that each type of hall chosen has the appropriate location and size for the participants. For example, if a hall number 7 template is selected, then the first participant should be placed on the Y axis in a particular pixel and on X axis In a particular pixel. It also knows that if one changed the size of the seats and reduced them, for example, by 40% due to the number of participants, the same reduction should be performed automatically for participants. So there is a complete match between the choice of hall and the video effect on people. All this is performed in steps 214 and 216.

As mentioned, the host may change these locations at any given moment. From the moment the final decision is made, any change in location is include both image channels alike—the hall and the people.

So in steps 212 and 218, the system transferred seats and participants to Layers 2 and 3. Ready for Key effect. The seats are placed according to the choice of template and the expected number of people and participants when they are already placed on the seats.

If KEY is not performed—one layer will hide the other. One might only see the movie or just the participants with a black frame behind them or just seats. Therefore, it is necessary to perform a KEY on Layer 2 and Layer 3.

It should be noted that the Key effect for Layer 2 and the Layer 3 is not the same effect. On Layer 2 the effect is automatic because it is a template. Layer 3 on the other hand, each participant provides the system with different conditions and it must adjust the effect to its image to allow it (as one mentioned in “Zoom”) to “clear” the background behind him For example, if one of the participants watches the film with a painting behind him, on the wall, after the key effect the result is that the picture is removed and behind him is seen the back of the virtual seat of the hall. What is the purpose of 222? Sometimes the system did not choose properly and provided for example 6 seats when only in the end there are only 3 participants There is no reason for the seats to be empty seats. These empty seats interfere with watching the movie even though they are usually located at the bottom of the image. For this purpose step 222 matches the number of seats to the viewer nail. Do not worry: A participant who arrived late is not be left standing—A chair is added to him automatically. All of these channel to step 224 in order to create the final frame and it is passed to all active viewing group members.

It must be noted that when one says this, the intention is not that a single frame is distributed among the members, but that the created pattern is used for the purpose of screening the entire video image. The film changes all the time as well as the video received from the participants' cameras, and the need to perform the KEY effect is exist throughout the screening, but the sizes and locations have been determined (until the next change by host or by system).

It is important to emphasize that some of the actions described here are optional only. There is users who is ask for example, to see the participants on screen without the chrome key effect and without the seats, perhaps because of their special fondness for the classic conference calls. The system responds positively to this nostalgia, and give them this option.

FIG. 3 illustrates a simple screen shot option obtained as a result of the method of FIG. 2. The film in the background, when in the foreground, on 5 chairs (separate in this case) sit the host and the 4 guests members in the joint screening. They are sitting on 5 theater chairs, may see each other, may communicate with each other by different means, and they are positioned in a way that does not interfere with watching the film. They may adjust their transparency, their size' their number (choose to see only 2 for example) and their position on the screen.

It is important to note that this structure of five chairs as shown in FIG. 3 is a simple example of a cinema hall format. There are dozens of possible templates in the archive of cinema halls and stadiums. In some, the chairs are adjacent to each other, or placed row by row, all according to the number of viewers, the automatic selection or the user's choice.

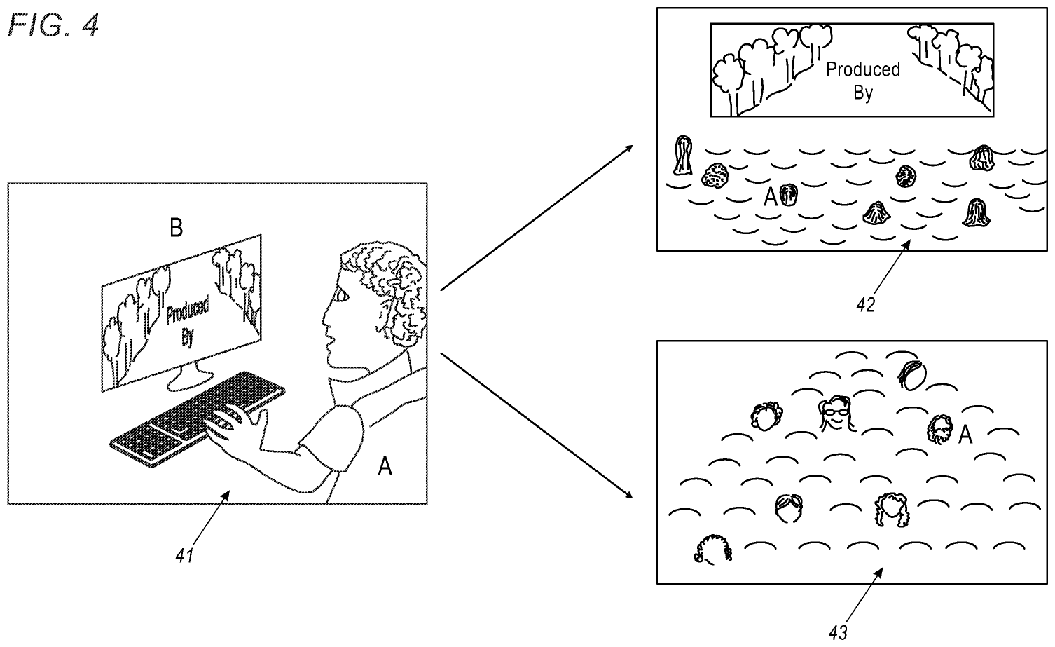

FIG. 4 is a simplified illustration showing a method for seating an individual user inside a virtual movie theater, in accordance with an embodiment of the present disclosure. It illustrates an exemplary relationship in 41 between User A watching the movie at home and being captured by camera B, and his character in the cinema hall in the back angle, 42, the same angle one see when one sit in a movie theater, and the front angle 43, as may be seen by him or by all participants.

FIG. 5 is a simplified illustration showing an exemplary relation between a user A, which during the session has turned his face to the right (51) and his figure (user A) in the theater, from the back (52) also turning its face to the right after its image as sent by its on-screen camera has been processed. 53 illustrates one of the options the user may choose: A view of the theater from the side. For example, if the user wants to see a football competition and feels he is in Wembley Stadium in London, he may do it, and the virtual viewers is placed in the stadium stands, or if he wants to see the opera as he sits in the hall designed by the Vienna Opera House, he may do so, and the audience watching the broadcast is located in the same hall. This user's choice is only affect his viewing experience, it is not affect other users, and each user is free to set the viewing experience for himself. In some embodiments, the host is able to decide the look for the whole group.

FIG. 6 illustrates and explains the football section. In the drawing one sees a template of a football stadium, one of many options, one of several templates available to the user. The stadium consists of the soccer (or Rugby) field A on which the real game is played. A is variable in size according to settings and user decisions. For example, he may watch the game full screen or decrease the game size and watch it together with the online viewers. Booths B and C are the main virtual booths where one may place the online viewers who watch the same game with the user, (and have their cameras on) ranging from a small number of spectators to a large number of spectators depending on user settings, the user's decisions and the size of the selected football field. The user may decide that he wants to see 10 viewers or 500 viewers on these stands. The other stands D, E, F are flexible in the same way but have another element: if the game is with real viewers present in the stadium, or one may place the online viewers that have their cameras on, or rather supplied a stills photo. Because the cameras normally supply a front image of the user, the audience located in D, E and F sits facing the user rather than the game. In the final version of the show, all audiences in each bidder is face foreward to the game after the information from their camera has been appropriately “processed” according to its location in the stadium by turning its frontal image into a profile or back-end image. In order to help the processing, the plan notifies the user that he is a candidate for the E stand, for example, and ask him to position his camera in accordance with the plan's instructions rather than frontal.

FIG. 7 illustrates an exemplary split screen. 71 and 72 are splits between TV and computer. The TV 71 show the game and the computer 72 screen show the audience. 73 and 74 illustrate splitting between TV and cell phone. The TV 73 shows the audience and the phone 74 shows the game.

FIG. 8 illustrates an exemplary situation where one may choose to “hide” the crowd, just like in reality, while the players partially hide from our eyes the audience sitting in the stands opposite. 81 represents the players hide the audience just as in reality. 82 represents the user has decided that he wants the audience to hide the game because he always prefers to see the audience and give his friends the priority.

FIG. 9 illustrates an exemplary situation: the camera is tracking or panning with a player moving from right to left. This tracking affects parallel movement on the audience (our group) in the same way and speed and direction to give an illusion as if one is really in the stadium. This aim to give the effect of reality as one is watching the players moving from left to right and the back ground is “moving” with them.

In 91, one sees on the left, friends number twenty five twenty six and twenty seven while the camera is panning after the player, one pans also on our friends and on the end of this pan on the left one is see friends number forty two forty three and forty four.

FIG. 10 describes some actions of adding a virtual upper body in the case of receiving a too close (close-up) from participant and is almost identical to FIG. 2 and has steps numbered using the same numerals, but it has one significant addition next to solving a problem that may arise in step 220. In some cases, the participant provides the system with only a close-up image (CU). He may be too close to the camera or the camera may have a long lens. In the virtual screening hall, on the other hand, he is supposed to show half of his upper body. When one looks (in front of) at spectators sitting in a movie theater or stadium one usually sees half of their upper body including their face of course. The system fixes this. For this purpose, the system may detect cases in which the user's face is too close, by comparing face size software, reducing the user's face size and adding a virtual artificial body from an existing catalog and moving the body according to the participant's head movements. The model of the body may be pre-selected by the user or is automatic.

Thus, the end result is that the participant is find himself sitting next to his friends, whom they see with their bodies as provided LIVE while he is the same size as them, but part of his upper body is provided by the system., Of course except taken from his live broadcast. For this purpose there is an intervention of Layer 4.

Although the techniques described here apply to any generic digital video distribution system, and in particular to systems using packet networks (e.g., IPTV) and public Internet (e.g., video services available on the Internet), the disclosure is focused on IPTV. Application of the disclosure to other digital video distribution systems may be achieved through trivial modifications and terminology changes.

Other suitable operations or sets of operations may be used in accordance with some embodiments. Some operations or sets of operations may be repeated, for example, substantially continuously, for a pre-defined number of iterations, or until one or more conditions are met. In some embodiments, some operations may be performed in parallel, in sequence, or in other suitable orders of execution

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Some embodiments may utilize client/server architecture, publisher/subscriber architecture, fully centralized architecture, partially centralized architecture, fully distributed architecture, partially distributed architecture, scalable Peer to Peer (P2P) architecture, or other suitable architectures or combinations thereof.

Some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described herein with reference to flow chart illustrations and/or block diagrams of methods, apparatus (systems) and computer program products according to embodiments of the disclosure. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow charts and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flow charts and/or block diagram block or blocks.

The flow charts and block diagrams in the figures illustrate the architecture, functionality, and operation of possible implementations of systems, methods and computer program products according to various embodiments of the present disclosure. In this regard, each block in the flow charts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow chart illustrations, and combinations of blocks in the block diagrams and/or flow chart illustrations, can be implemented by special purpose hardware-based systems that perform the specified functions or acts, or combinations of special purpose hardware and computer instructions.

Although the embodiments described above mainly address assessing test coverage of software code that subsequently executes on a suitable processor, the methods and systems described herein can also be used for assessing test coverage of firmware code. The firmware code may be written in any suitable language, such as in C. In the context of the present patent application and in the claims, such code is also regarded as a sort of software code.

The references cited herein teach many principles that are applicable to the present disclosure. Therefore the full contents of these publications are incorporated by reference herein where appropriate for teachings of additional or alternative details, features and/or technical background.

It is to be understood that the disclosure is not limited in its application to the details set forth in the description contained herein or illustrated in the drawings. The disclosure is capable of other embodiments and of being practiced and carried out in various ways. Those skilled in the art will readily appreciate that various modifications and changes can be applied to the embodiments of the disclosure as hereinbefore described without departing from its scope, defined in and by the appended claims.

What is claimed is:

1. A method for creating a shared viewing experience of an event at an event venue, the method comprising:
a) receiving from one participant in a network a request for joint viewing of a video or movie from the network;
b) forwarding the request to predefined additional potential participants to consent to participate in the shared viewing experience of the event;
c) creating a real time new video which includes three video layers; and
d) broadcasting the new real time video to all participants that consented to participate.

2. A method according to claim 1, wherein the event is selected from a movie, a theater production, a sports event, a communal event, an educational event, a medical event and combinations thereof.

3. A method according to claim 1, wherein the event venue is selected from a movie theater (cinema), a theater, a sports venue, a community center, a religious services center, an educational establishment and a medical establishment.

4. A method according to claim 1, wherein the three video layers comprise a video content layer, a video event venue layer, and a video event participant layer.

5. A method according to claim 4, wherein the creating the video content comprises combining digital visual effects, motion graphics and video content.

6. A method according to claim 5, wherein the creating the video event venue layer comprises choosing an event venue responsive to a number of consenting participants.

7. A method according to claim 6, wherein the video event participant layer comprises superimposing images of said number of consenting participants at said events venue.

8. A method according to claim 7, wherein the creating the video event participant layer comprises superimposing virtual images of said participants with at least one of a real images and video of the event venue.

9. A method according to claim 8, wherein the broadcasting step comprises broadcasting said video content layer appearing to occur at said event venue with said images of said number of consenting participants.

10. A system for creating a shared viewing experience of an event at an event venue, the system comprising:
a) a network for receiving from one participant a request for joint viewing of a video or movie;
b) a plurality of smart devices with screens, each smart device configured to communicate with the other smart devices of the plurality of smart devices via the network and further to forward the request to predefined additional potential participants to consent to participate in the shared viewing experience of the event; and
c) a processor configured to create a real time new video including three video layers and to broadcast the new real time video to all participants that consented to participate via the network to the plurality of smart devices.

11. A system according to claim 10, wherein said three video layers comprise a video content layer, a video event venue layer, and a video event participant layer.
